(19) United States
(12) Patent Application Publication
(10) Pub. No.: US 2015/0082347 A1
(43) Pub. Date: Mar. 19, 2015

(54) Delivering Video Program by Digital Television System and Mobile Communication Device

(71) Applicant: Yang Pan, Singapore (SG)

(72) Inventor: Yang Pan, Singapore (SG)

(21) Appl. No.: 14/032,185

(22) Filed: Sep. 19, 2013

(51) Int. Cl. H04N 21/41; H04N 21/433; H04N 21/81; H04N 21/482

(52) U.S. Cl. CPC H04N 21/4126; H04N 21/482; H04N 21/4333; H04N 21/4332; H04N 21/812
USPC 725/38

(57) ABSTRACT

A video program broadcasted by a digital television system includes a plurality frames delivered in a sequential manner. One of the frames representing a starting point of an unfinished program can be transmitted to a mobile communication device. An icon representing the frame is created by the mobile device. The icon maybe placed in a folder for photographs. In one embodiment, the unfinished video program is restarted in the mobile device after a user selects the icon. In another embodiment, the unfinished video program is restated in the television system.

### CROSS-REFERENCE TO RELATED APPLICATIONS

Not applicable.

### BACKGROUND

1. Field of Invention

This invention relates generally to media asset delivery. More specifically, the invention relates to system and method for delivering a video program through the use of a digital television system and a mobile computing and communication device.

2. Description of Prior Art

Mobile communication devices have gained significant popularity in recent years. Users are using the mobile device such as, for example, iPhone, iPod and iPad from Apple Inc, Cupertino, Calif., to enjoy media assets and to access the Internet services. Methods for delivering video programs to users by employing mobile communication devices have been developed.

Because of significantly larger display size and comfortable environment in a living room, many of video programs have still been delivered to users through a digital television system. However, a user is often disrupted for different engagements when viewing a video program. A video program being rendered has to be paused or be stopped sometimes.

Therefore, it is desirable to have a flexible video program delivery system which can be employed to deliver an unfinished video program either through one of the mobile communication devices or through the digital television system in a later time.

### SUMMARY OF THE INVENTION

It is an object of the present invention to disclose a system and method providing flexibility for delivering an unfinished video program using different personal devices.

It is another object of the present invention to provide a simple graphical user interface for a user to select one of the devices to resume the unfinished video program.

In accordance with one embodiment of the present invention, the digital television (TV) system is used to deliver a program to a user. The program comprises a series of frames or images. The unfinished program is associated with one of the frames, which may be the first frame for the unfinished program. The user actuates the mobile communication device to send a control signal to the digital TV system. Upon receiving the control signal, the digital TV system selects the frame and transmits the frame to the mobile device. A processor in the mobile device creates an icon to represent received frame. In one implementation, the icon includes the frame in a reduced size. The icon may be placed in a first display screen of the mobile device. The icon may also be placed in a folder such as, for example, a folder pertaining to storing photographs.

In one implementation, digital TV system receives a user's instruction through the mobile device to store remaining portion of the unfinished video program in a storage unit of the digital TV system.

When the user wants to resume the video program, one can simply select the icon. The video program can be resumed through mobile device. Contents of the video program can be transmitted to the mobile device through a communication network.

In another embodiment, the unfinished video program may be resumed through the digital television system. The user can use the mobile device to send a control signal to the digital television system through a reestablished ad hoc communication link. The control signal is generated by the mobile device after the user selects the icon.

In another aspect of the present invention, the user needs to view an advertising message or pay for resuming the video program.

### BRIEF DESCRIPTION OF THE DRAWINGS

For a more complete understanding of the present invention and its various embodiments, and the advantages thereof, reference is now made to the following description taken in conjunction with the accompanying drawings, in which:

FIG. 1 is a schematic diagram of an exemplary video delivery system based on a digital TV system and a mobile communication device;

FIG. 2 is a functional block diagram of an exemplary digital TV system;

FIG. 3 is a functional block diagram of an exemplary mobile communication device;

FIG. 4 is a schematic diagram illustrating that an icon representing the frame is placed in a folder for photographs.

FIG. 5 is a flowchart illustrating an exemplary process that a video program is resumed by employing the exemplary video delivery system.

FIG. 6 is a flowchart illustrating an exemplary process that remaining portion of an unfinished video program is stored in a storage unit of the digital TV system.

FIG. 7 is a flowchart illustrating an exemplary process that a device for resuming the video program is selected.

### DETAILED DESCRIPTION

One or more specific embodiments of the present invention will be described below. These described embodiments are only exemplary of the present invention. Additionally, in an effort to provide a concise description of these exemplary embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business related constraints, which may vary from one implementation to another. Moreover, it should be appreciated that such a development effort might be complex and time consuming, but would nevertheless be a routine undertaking of design, fabrication, and manufacture for those of ordinary skill having the benefits of this disclosure.

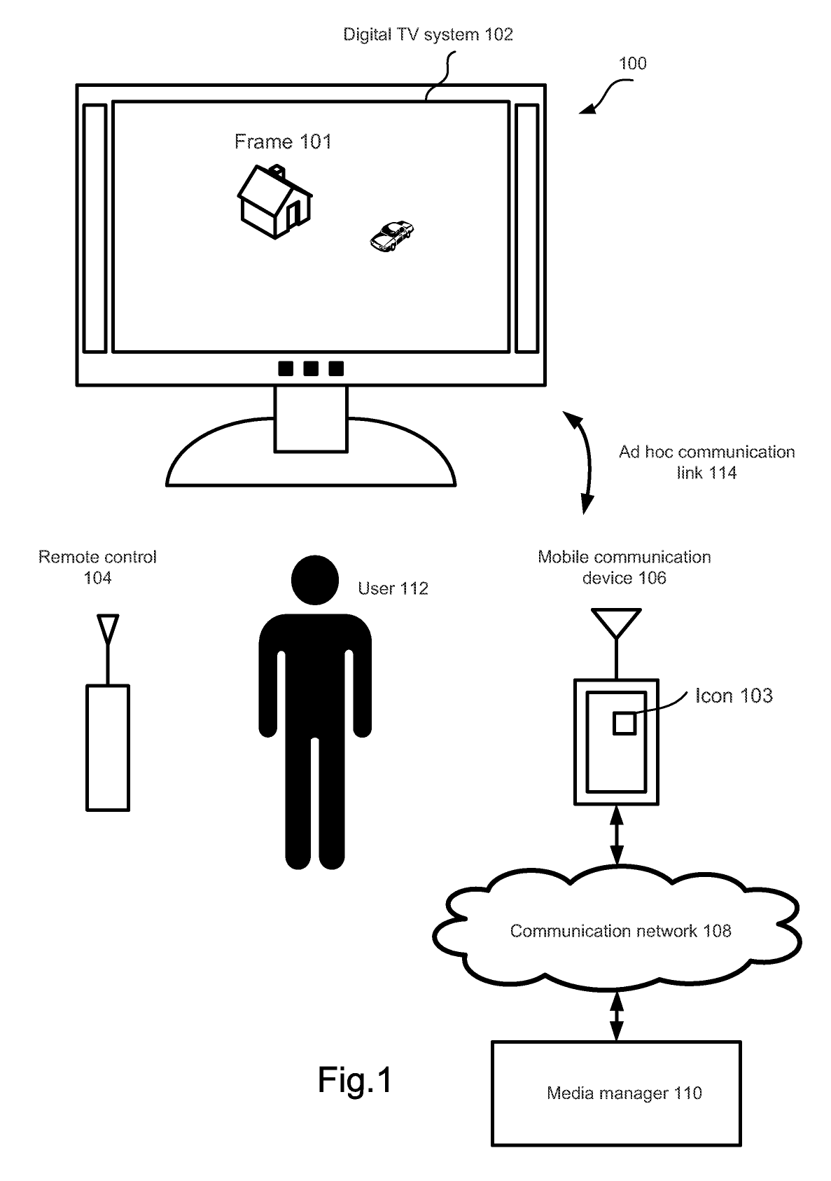

FIG. 1 is a schematic diagram illustrating an exemplary video delivery system according to one embodiment. System 100 comprises digital TV system 102 with a remote control device 104. Digital TV system 102 is connected to a communication network and is controlled by a computing device such as, for example, a set top box. Mobile communication device 106 can take various forms that include but are not limited to a smart phone, a tablet computer, a media player, a laptop computer, a wearable communication device and a game console. Digital TV system 102 and mobile device 106 can be connected through an ad hoc communication link 114. In one implementation, user 112 employs remote control 104 to control digital TV system 102. In another implementation, user 112 employs mobile device 106 to control digital TV system 102 through ad hoc communication link 114. In still another implementation, digital TV system 102, remote control 104 and mobile device 106 form an ad hoc communication network (not shown in FIG. 1). The ad hoc communication link 114 may be conformed to various IEEE and ISO standards and their extensions such as, for example, IEEE 802.15.1 (Bluetooth), IEEE 802.15.4 (ZigBee), IEEE 802.11x (WiFi) and ISO 18092, ISO 21481 and Transfer Jet Protocol for Near Field Communication (NFC).

Mobile device 106 is connectable to a media manager 110 through communication network 108. In a preferred implementation, communication network 108 is the Internet. Digital TV system 102 may be connected to the same media manager 110 through the same communication network 108. Digital TV system 102 may be connected to a different media manager through a different communication network. Media manager 110 provides media assets to user 112. An exemplary media manager is iTunes from Apple Inc, Cupertino, Calif.

A video program can be rendered by digital TV system 102. The video program can be rendered on a user's demand. The video program can also be broadcasted according to a predetermined schedule. The video program includes a plurality of frames delivered in a sequential manner.

If user 112 needs to move away from digital TV system 102, he or she actuates an input device of mobile device 106 to send a control signal to digital TV system 102 according to one embodiment. User 112 may touch a related application icon displayed on a touch-sensitive display of mobile device 106 to send the control signal. User 112 may also actuate a button, a keyboard or a touchpad as known in the art to send the control signal.

Upon receiving the control signal, digital TV system 102 selects frame 101 being displayed as a bookmark that defines pausing point of the video program. The video program is therefore divided into a first portion that has been rendered and a second portion or remaining portion that has not been rendered. A data file including frame 101 is transmitted to mobile device 106 through ad hoc link 114. After receiving the data file, a processor in mobile device 106 creates an icon 103 that represents received frame 101. In one implementation, icon 103 is placed in a folder such as, for example, in a folder dedicated for storing photographs. In another implementation, icon 103 is placed in a dedicated folder for storing icons representing pausing points of video or TV programs. In still another implementation, icon 103 is displayed in a first display screen of mobile device 106.

Icon 103 may include a reduced size image of frame 101 in a manner similar to storing a photograph. Icon 103 may include a text comprising metadata of the video program. Icon 103 may be associated with animations.

After receiving the control signal by digital TV system 102, a processor in digital TV system 102 stores frame 101 in a data storage unit. In one implementation, the remaining portion of the video program may be transferred from the media manager to digital TV system 102 through the communication network. The received remaining portion of the video program can be stored in the data storage unit of digital TV system 102. In a somehow different implementation, only a part of remaining portion of the video program is transferred and be stored in the storage unit.

If the video program is broadcasted according to a predetermined schedule, the remaining portion of the program may be recorded and be stored in the data storage unit.

At the moment that the control signal is received, digital TV system 102 may request user 112 to send a selection through mobile device 106 if the remaining portion will be transferred from the network or be recorded by digital TV system 102. This is an optional feature and should not limit scope of the present inventive concept.

In one aspect of the present invention, user 112 may want to resume the paused video program by employing mobile device 106. User 112 selects the icon by actuating an input device such as, for example, by touching icon 103 displayed on the touch-sensitive display. Upon receiving the user's selection, mobile device 106 starts an operation to render the remaining portion of the video program. Frame 101 is used as the starting point of the resumed program. The remaining portion of the video program is transferred from media manager 110 to mobile device 106 through communication network 108. In a somehow different implementation, a part of the remaining portion of the video program can be downloaded and be stored in a data storage unit of mobile device 106. The pre-stored part will help to improve media delivery experience when data transfer from media manager 110 to mobile device 106 is not fast enough to support a high quality delivering of the video program.

In another aspect, user 112 may want to resume the paused video program in a later time after mobile device 106 and digital TV 102 is reconnected through reestablishing of ad hoc communication link 114. User 112 selects icon 103. Mobile device 106 transmits a control signal to digital TV system 102. In one implementation, frame 101 is transmitted to digital TV system 102. After receiving frame 101, the processor of digital TV system 102 identifies the video program that was paused previously and resumes rendering the remaining portion of the video program starting from frame 101. In another implementation, an identification code associated with frame 101 rather than frame 101 is transmitted from mobile device 106 to digital TV system 102.

When user 112 selects icon 103 for resuming the video program, mobile device 106 may display a user interface requesting the user to select either mobile device 106 or digital TV system 102 to render the video program.

In another embodiment, remote control 104 is employed to send a control signal and put the video program being rendered or being broadcasted into a status of pause. Frame 101 may optionally be frozen on display of digital TV system. In response to the control signal from the remote control 104, digital TV system 102 transmits a data file including frame 101 to mobile device 106.

In yet another embodiment, video delivery system comprises digital TV system 102 and remote control 104. Mobile device 106 is absent. Upon receiving the control signal from remote control 104, video program being rendered or being broadcasted is put into a pause status. Subsequently, an icon is created by the processor of digital TV system 102. The icon may include an image of frame 101 in a reduced size. In one implementation, the icon may be displayed in a predetermined position of the display of digital TV system 102. The predetermined positions include but are not limited to one of four corners of the display. The icon may also be stored in a folder of digital TV system 102. User 112 can select the icon by employing remote control 104. Upon the user's selection, video program will be resumed. Similarly, the remaining portion of the video program may be transferred from a media manager in the network. The remaining portion of the video program may also be recorded and be stored in the data storage unit of digital TV 102.

In some embodiments, advertising message will need to be viewed by user 112 before the video program is resumed. The advertising messages may be related to the user's identity. The user's identity may be sent from mobile device 106 to digital TV system 102.

In some other embodiments, the remaining portion of the video program may need to be purchased from the media manager.

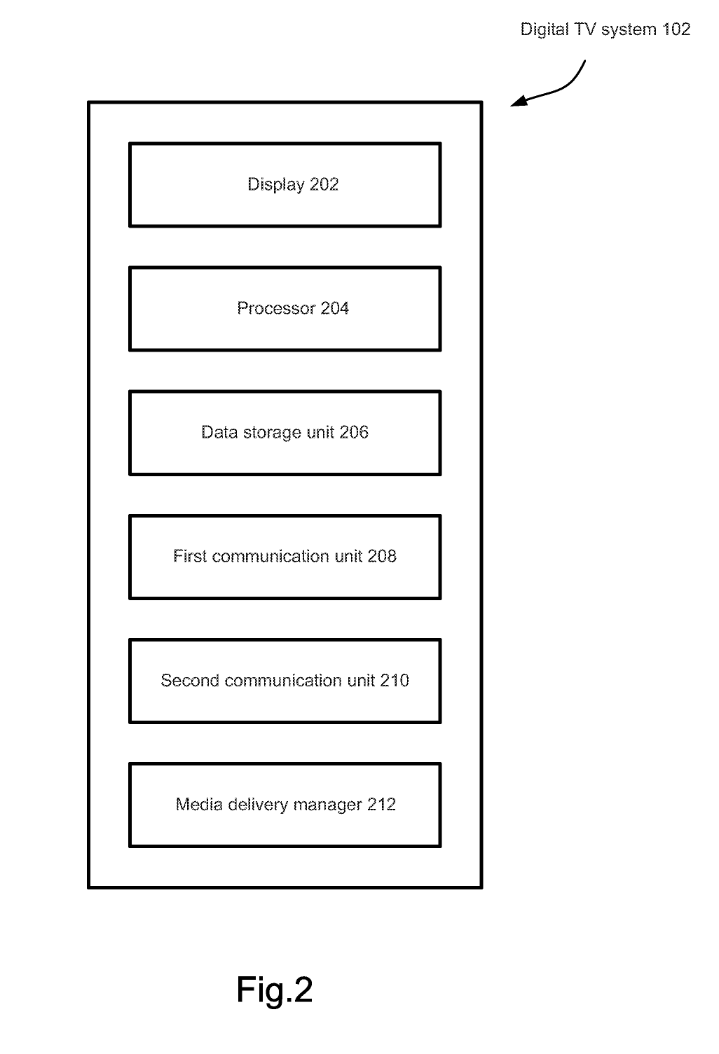

FIG. 2 is a schematic representation of functional blocks of an exemplary digital TV system 102. Digital TV system 102 comprises a display 202. Display 202 may be a Liquid Crystal Display (LCD). Display 202 may also be any other type of display as known in the art. Processor 204 is used to control the operation of digital TV system 102. Processor 204 may include more than one type of processors including a general purpose processor such as a Central Processing Unit (CPU) and a special purpose processor such as a Graphical Processing Unit (GPU). Digital TV system 102 also includes data storage unit 206 such as, for example, a magnetic storage unit and/or semiconductor memory devices.

Digital TV system 102 is connected to a communication network through a first communication unit 208. The network may be a private broadband network for delivering TV programs. The network may also be a public network such as, for example, the Internet. Second communication unit 210 is used to connect digital system 102 to mobile device 106 through ad hoc communication link 114. Ad hoc communication link 114 may be conformed to various IEEE and ISO standards and their extensions such as, for example, IEEE 802.15.1 (Bluetooth), IEEE 802.15.4 (ZigBee), IEEE 802.11x (WiFi) and ISO 18092, ISO 21481 and Transfer Jet Protocol for Near Field Communication (NFC). Digital TV system 102 may also include a third communication unit (not shown in the figure) for connecting the system and the remote control device 104. Most remote control devices today use Infrared communication interfaces. Media delivery manager 212 is pertaining to managing rendering, pausing, storing, transferring the video program and related frames. Media delivery manager 212 may be implemented as a software program to be executed by the processor 204. Media delivery manager 212 may also be implemented as a combination of the software and the hardware.

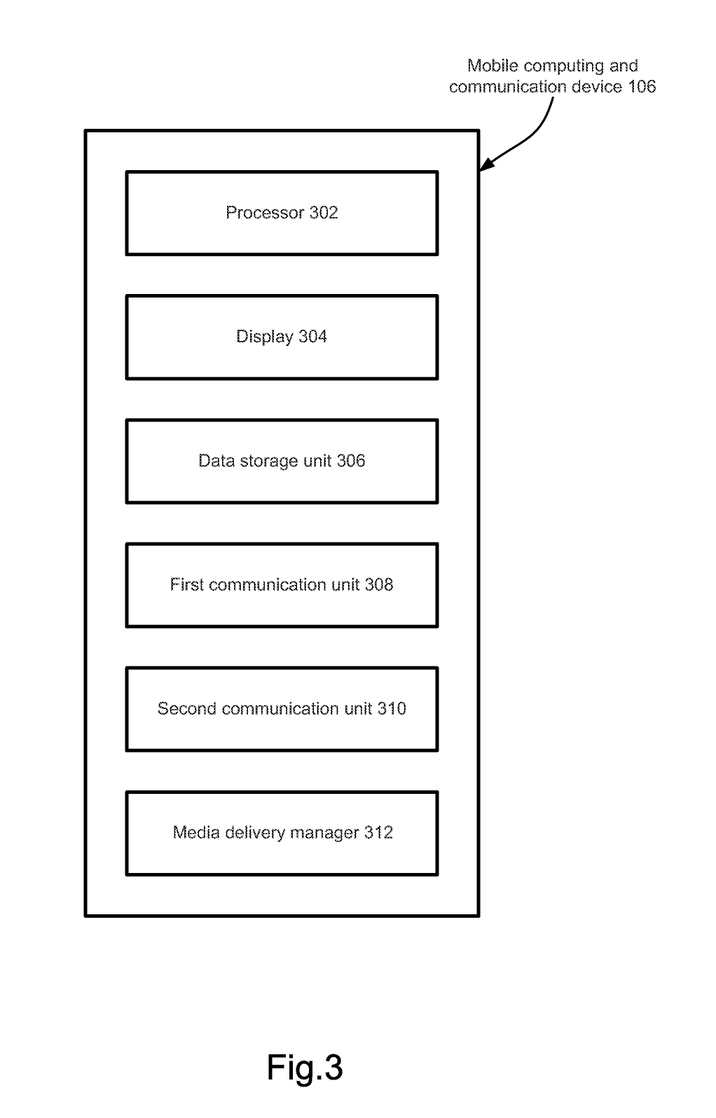

FIG. 3 is a schematic representation of functional blocks of an exemplary mobile communication device 106. Device 106 comprises processor 302, display 304, a data storage unit 306 and a first communication unit 308. The first communication unit 308 may be a standard network interface for a smart phone including a capability to connect to the Internet. Mobile device 106 further comprises a second communication unit 310 for connecting to digital TV system 102 through the previously mentioned ad hoc communication link 114. Media delivery manager 312 is pertaining to managing rendering, receiving, storing and transferring the video program and related frames. Media delivery manager 312 may be implemented as a software program to be executed by the processor 302. Media delivery manager 312 may also be implemented as a combination of the software and the hardware.

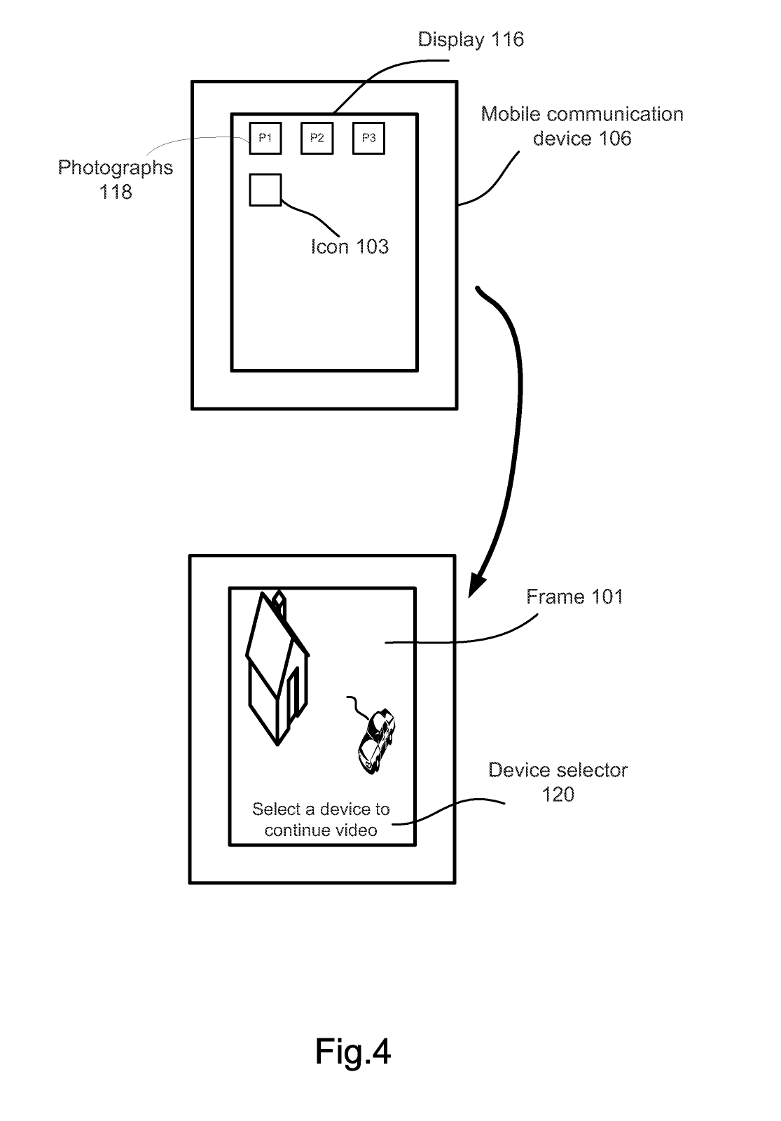

FIG. 4 is a schematic diagram illustrating received frame is stored in an exemplary manner in a folder for photographs by a mobile communication device 106. The folder as displayed on a display screen 116 of mobile device 106 includes multiple icons for photographs illustrated exemplarily as P1, P2 and P3. An icon for a photograph includes typically an image of the photograph with a reduced size. Icon 103 may be displayed in a similar manner as an icon for a photograph. Icon 103 may include an image for frame 101 with a reduced size.

According to one embodiment, user 112 selects icon 103 through an input device such as, for example, through touching the icon displayed on a touch-sensitive display. In response to the user's selection, frame 101 is displayed on the display screen 116. In one implementation, the processor of mobile device 106 displays a user interface: device selector 120, requesting the user to select a device to resume the video program. If the user selects mobile device 106, the remaining portion of the video program will be rendered by employing of the mobile device. If the user selects digital TV system 102, the remaining portion of the video program will be rendered by employing of the digital TV system. In the later case, mobile device 106 and digital TV system 102 have to be reconnected through ad hoc communication link 114.

In another implementation, the video program will be resumed starting from frame 101 through mobile communication device 106 if mobile device 106 is not connected to digital TV 102.

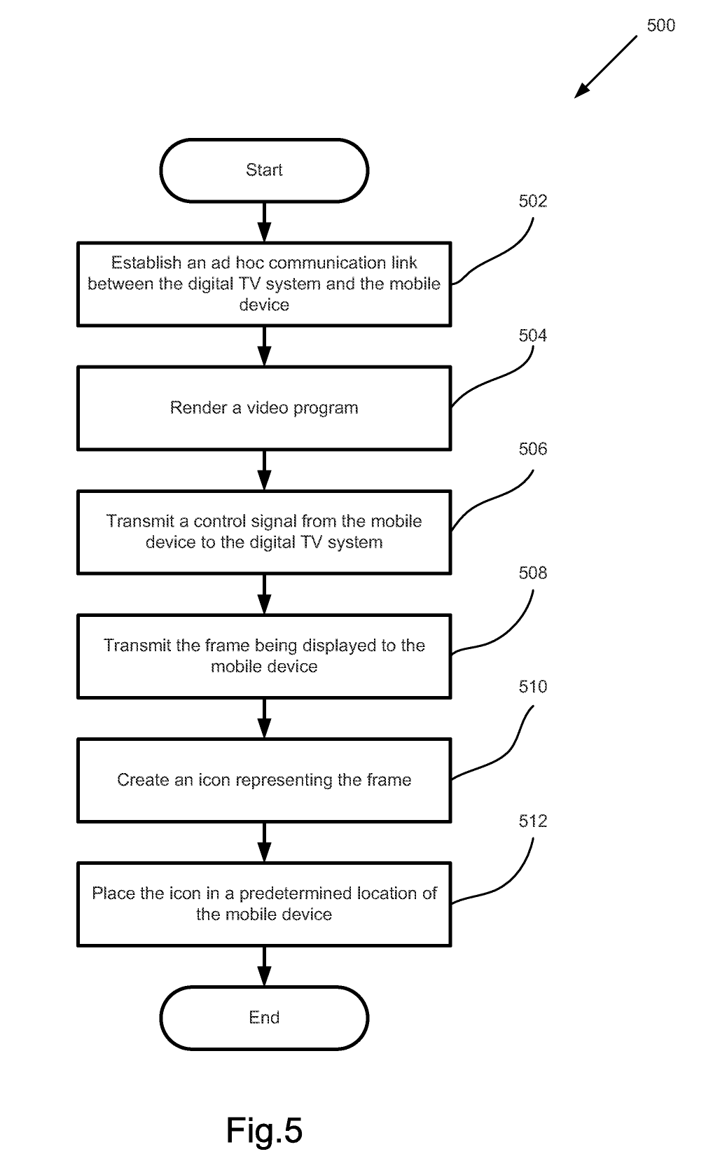

FIG. 5 is a flowchart illustrating an exemplary process that a video program is paused and a bookmark in a form of an icon is created in mobile device 106. Process 500 starts with step 502 that an ad hoc communication link 114 is established between digital TV system 102 and mobile communication device 106. Communication link 114 may be a Bluetooth type of connection in an exemplary implementation. The communication link may also be a Wi-Fi type of connection. A video program is rendered through digital TV system 102 in step 504. The video program may be rendered based upon the user's demand. The video program may be a TV program that is broadcasted according to a predetermined schedule. A control signal is transmitted from mobile device 106 to digital TV system 102 through ad hoc communication link 114 in step 506 after the user actuates an input device of mobile device 106. Upon receiving the control signal, a processor of digital TV system records the frame being displayed as a point of pausing for the video program. The frame may be associated with an identification code. A video program in a digital form may include an address for each of the frames. The frame identification code maybe related to the address. A data file including the frame is transmitted from digital TV system 102 to mobile device 106 in step 508 through ad hoc communication link 114. The data file may also include the identification code. Upon receiving the frame, a processor in mobile device 106 creates an icon representing the frame in step 510. In one implementation, the icon is an image of the frame in a reduced size. In step 512, the icon is placed in a predetermined location of mobile device 106. In one implementation, the icon is placed in a folder dedicated for photographs. In another implementation, the icon is placed in a dedicated folder for frames. In still another implementation, the icon is placed at the first display screen of the mobile device 106.

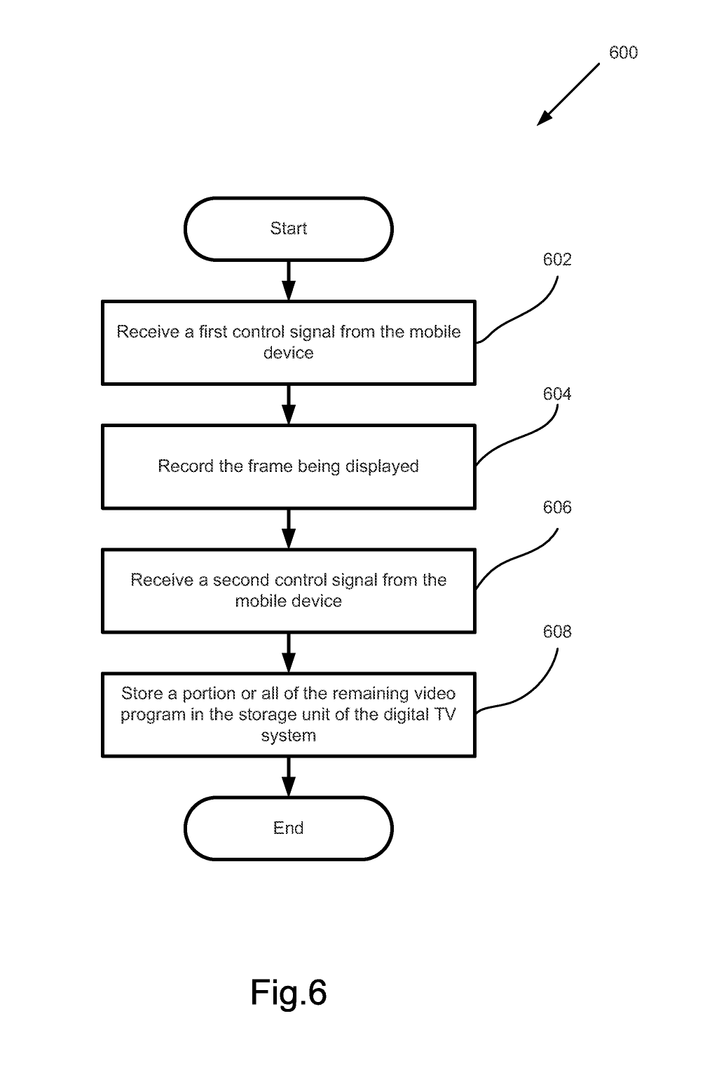

FIG. 6 is a flowchart illustrating an exemplary process that remaining portion of an unfinished video program is stored in a storage unit of the digital TV system 102. Exemplary process 600 starts with step 602 that a first control signal transmitted from mobile device 106 is received by digital TV system 102. The control signal is triggered by the user's actuation of an input device of mobile device 106. Upon receiving the control signal, a processor in digital TV system 102 records a frame being displayed in step 604. Digital TV system 102 receives a second control signal from mobile device 106 in step 606. The second control signal may be triggered by the user's selection of one of two means for receiving the remaining portion of the video program. A first means includes receiving the remaining portion of the video program from a media manager in the network. A second means includes recording of the program being broadcasted. In one implementation, the user selectable means may be displayed on mobile device 106. In another implementation, the user selectable means may be displayed on digital TV system. The user makes selection through actuating an input device of mobile device 106. Received remaining portion of the video program is stored in the data storage unit of digital TV system 102 in step 608.

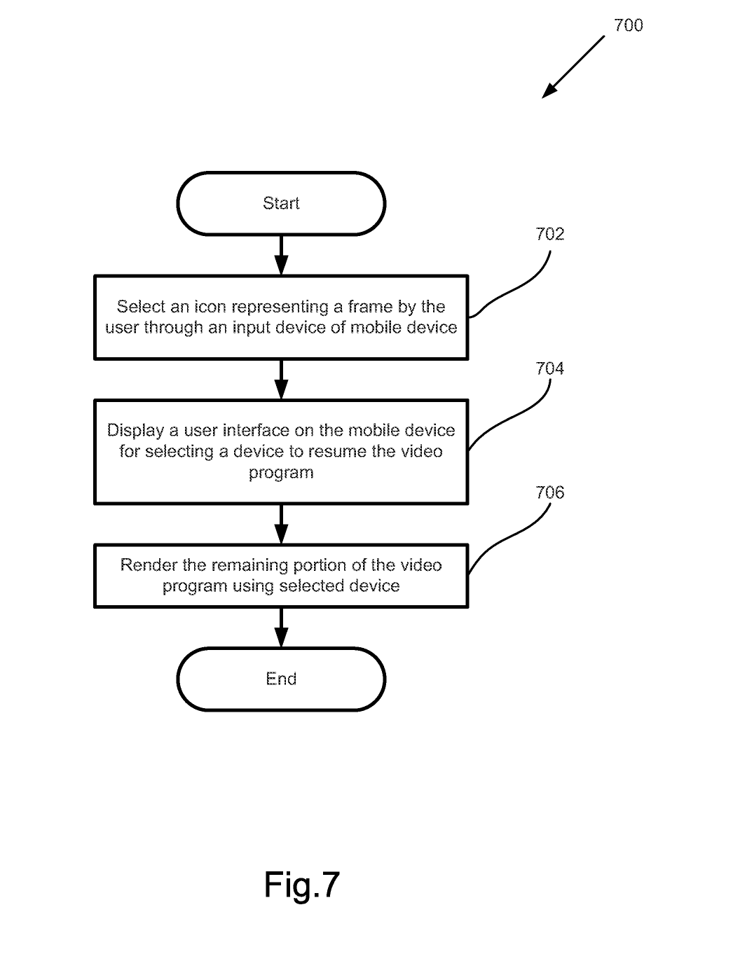

FIG. 7 is a flowchart illustrating an exemplary process that a device for resuming the video program is selected. Exemplary process 700 starts with step 702 that an icon representing the frame at the pausing point of the video program is selected by the user through an input device of mobile device 106. A user interface including user selectable devices for resuming the video program is displayed on mobile device 106 or on digital TV system 102 in step 704. The user selectable devices include digital TV system 102 and mobile device 106. In step 706, the remaining portion of the video program is rendered through the selected device.

1. A method of delivering a video program comprising:
a. rendering the video program through a digital television system, said video program further comprising a plurality frames displayed in a sequential manner;
b. receiving a control signal from a mobile computing and communication device through an ad hoc communication link between the television system and the mobile device;
c. transmitting a frame being displayed from the television system to the mobile device through the ad hoc communication link;
d. creating an icon by a processor of the mobile device, said icon is a representation of the received frame,
e. selecting the icon by a user through an input device of the mobile device; and
f. rendering remaining portion of the video program through the mobile device, said remaining portion of the video program is transmitted from a media manager in a communication network.

2. The method as recited in claim 1, wherein said icon is placed in a first display screen of the mobile device.

3. The method as recited in claim 1, wherein said icon is placed in a folder.

4. The method as recited in claim 3, wherein said folder pertaining to storing photographs.

5. The method as recited in claim 3, wherein said folder pertaining to storing frames representing uncompleted video programs.

6. The method as recited in claim 1, wherein said icon further including an image of the frame with a reduced size.

7. The method as recited in claim 1, wherein said rendering remaining portion of the video program is started after viewing an advertising message.

8. The method as recited in claim 1, wherein said ad hoc communication links further include a Bluetooth type of link.

9. The method as recited in claim 1, wherein said mobile communication device further comprises a smart phone.

10. The method as recited in claim 1, wherein said mobile communication device further comprises a tablet computer.

11. A method of delivering a video program comprising:
a. rendering the video program through a digital television system, said video program further comprising a plurality frames displayed in a sequential manner;
b. receiving a control signal from a mobile computing and communication device through an ad hoc communication link between the television system and the mobile device;
c. transmitting a frame being displayed from the television system to the mobile device through the ad hoc communication link;
d. creating an icon by a processor of the mobile device, said icon is a representation of the received frame,
e. selecting the icon representing the frame by a user through an input device of the mobile device;
f. transmitting selected frame from the mobile device to the television system through the ad hoc communication link;
g. rendering remaining portion of the video program through the television system, said remaining portion of the video program is stored in a data storage unit of the television system, said remaining portion of the video program is transmitted from a media manager in the network.

12. The method as recited in claim 11, wherein said icon is placed in a first display screen of the mobile device.

13. The method as recited in claim 11, wherein said icon is placed in a folder.

14. The method as recited in claim 13, wherein said folder pertaining to storing photographs.

15. The method as recited in claim 13, wherein said folder pertaining to storing frames representing uncompleted video programs.

16. The method as recited in claim 11, wherein said icon further including an image of the frame with a reduced size.

17. The method as recited in claim 11, wherein said rendering remaining portion of the video program is started after viewing an advertising messages.

18. A method of delivering a video program comprising:
a. rendering the video program through a digital television system, said video program further comprising a plurality frames displayed in a sequential manner;
b. receiving a control signal from a mobile computing and communication device through an ad hoc communication link between the television system and the mobile device;
c. transmitting a frame being displayed from the television system to the mobile device through the ad hoc communication link;
d. creating an icon by a processor of the mobile device, said icon is a representation of the received frame,
e. selecting the icon representing the frame by a user through an input device of the mobile device;
f. transmitting selected frame from the mobile device to the television system through the ad hoc communication link;
g. rendering remaining portion of the video program through the television system, said remaining portion of the video program is stored in a data storage unit of the television system, said remaining portion of the video program is recorded while the video program is being broadcasted.

19. The method as recited in claim 18, wherein said icon is placed in a folder pertaining to storing photographs.

20. The method as recited in claim 18, wherein said icon further including an image of the frame with a reduced size.
